(19) United States
(12) Patent Application Publication
(10) Pub. No.: US 2024/0335743 A1
(43) Pub. Date: Oct. 10, 2024

(54) Method for Playing Back Virtual Scene, Medium, Electronic Device, and Computer Program Product

(71) Applicant: Shanghai Lilith Technology Corporation, Shanghai (CN)

(72) Inventor: Zhi Cheng, Shanghai (CN)

(21) Appl. No.: 18/682,333

(22) PCT Filed: Jan. 24, 2022
(86) PCT No.: PCT/CN2022/073443

§ 371 Date: Feb. 8, 2024

(51) Int. Cl. A63F 13/497; G06T 13/40; G06T 17/00

(52) U.S. Cl. CPC A63F 13/497; G06T 13/40; G06T 17/00

(57) ABSTRACT

A method for playing back a virtual scene, a medium, an electronic device, and a computer program product. The method is used for an electronic device, and the method includes: receiving a recording instruction to record state data at beginning of the recording and change data during a recording process, of the virtual scene including at least one model (S10); and receiving a playback instruction, and playing back the virtual scene based on the state data and the change data, where, when the virtual scene is played back, an operation instruction is received and an operation result is displayed, and the operation instruction includes controlling at least one model of the virtual scene and/or generating an interaction event with at least one model of the virtual scene (S11). The method can control the playback virtual scene and/or interact with the playback virtual scene, so that user experience is improved.

### TECHNICAL FIELD

The present disclosure relates to data processing, and in particular, to a method for playing back a virtual scene, a medium, an electronic device, and a computer program product.

### BACKGROUND

For implementation of recording a game process and playing back a game process, video recording or recording an operation instruction of a player is usually adopted in the prior art. When video recording is adopted, a played back virtual scene usually depends on an angle of a camera of a recorder, and a viewer cannot use a free view to watch the content of any view in the virtual scene. When an operation instruction of a player is recorded, it is usually not convenient to quickly adjust the playback progress. In addition, the viewer can only watch the game process of the recorder, and cannot enter and interact with the played back virtual scene. Additionally, the quality of the playback content depends on a performance of a device of the recorder, and the quality of the virtual scene recorded by a low-end device is often low.

### SUMMARY

Embodiments of the present disclosure provide a method for playing back a virtual scene, a medium, an electronic device, and a computer program product.

According to a first aspect, an embodiment of the present disclosure provides a method for playing back a virtual scene, used for an electronic device, the method comprising: receiving a recording instruction to record state data at beginning of the recording and change data during a recording process, of the virtual scene comprising at least one model; and receiving a playback instruction, and playing back the virtual scene based on the state data and the change data, wherein, when the virtual scene is played back, an operation instruction is received and an operation result is displayed, the operation instruction includes controlling at least one model of the virtual scene and/or generating an interaction event with at least one model of the virtual scene.

In a possible implementation of the first aspect, the controlling at least one model of the virtual scene includes: controlling at least one existing model in the virtual scene, or, adding a new model in the virtual scene based on the operation instruction and controlling the new model.

In a possible implementation of the first aspect, the generating the interaction event with at least one model of the virtual scene comprises: adding a new model to the virtual scene based on the operation instruction, so that an interaction event is generated between at least one existing model in the virtual scene and the new model.

In a possible implementation of the first aspect, the method further includes: ending the playback in a case that at least one model of the virtual scene is controlled and/or an interaction event is generated with at least one model of the virtual scene.

In a possible implementation of the first aspect, the state data includes: a physical form, a position, and an action of the at least one model.

In a possible implementation of the first aspect, the change data includes the state data that is changed and that is recorded at predetermined time intervals.

In a possible implementation of the first aspect, the playing back the virtual scene based on the state data and the change data further includes: determining resolutions of the at least one model according to a performance parameter of the electronic device or the operation instruction, and rendering and playing back the virtual scene based on modeling data of the at least one model.

In a possible implementation of the first aspect, the operation instruction further includes: pausing or resuming playing back the virtual scene; or adjusting a viewing angle of the playback; or adjusting a progress of the playback.

According to a second aspect, an embodiment of this disclosure provides an apparatus for playing back a virtual scene. The apparatus includes: a recording unit, configured to record state data at beginning of the recording and change data during a recording process, of the virtual scene comprising at least one model; and a playback unit, configured to receive a playback instruction, and play back the virtual scene based on the state data and the change data, wherein, when the virtual scene is played back, an operation instruction is received and an operation result is displayed, the operation instruction includes controlling at least one model of the virtual scene and/or generating an interaction event with at least one model of the virtual scene. The recording unit and the playback unit may be implemented by a processor having functions of these modules or units in the electronic device.

According to a third aspect, an embodiment of the present disclosure provides a computer-readable storage medium having stored thereon instructions configured to, when executed on a computer, cause the computer to perform the method for playing back a virtual scene according to the first aspect.

According to a fourth aspect, an embodiment of the present disclosure provides an electronic device, including: one or more processors; and one or more memories; one or more programs are stored in the one or more memories, and when the one or more programs are executed by the one or more processors, the electronic device is caused to perform the method for playing back a virtual scene according to the first aspect.

According to a fifth aspect, an embodiment of the present disclosure provides a computer program product, including computer-executable instructions, and the instructions are executed by a processor to implement the method for playing back a virtual scene according to the first aspect.

In the present disclosure, the amount of data recorded during recording can be reduced, so that occupation of storage space is reduced. Further, in the present disclosure, even if the performance of the electronic device for recording the virtual scene is low, the high-quality virtual scene can be played back smoothly on the high-performance electronic device for playing back. Still further, in the present disclosure, the viewer can be allowed to use a free angle of view to watch the content in the playback virtual scene. Yet still further, in the present disclosure, it can not only play back the virtual scene, but also control the playback virtual scene and/or interact with the playback virtual scene, so as to improve user experience.

### BRIEF DESCRIPTION OF DRAWINGS

FIG. 1 is a schematic flowchart of a method for playing back a virtual scene according to some embodiments of the present disclosure;

FIG. 2 is a structural diagram of an apparatus for playing back a virtual scene according to some embodiments of the present disclosure; and

FIG. 3 is a block diagram of an electronic device according to some embodiments of the present disclosure.

### DETAILED DESCRIPTION OF EMBODIMENTS

Illustrative embodiments of the present disclosure include, but are not limited to, a method for playing back a virtual scene, a medium, an electronic device, a computer program product.

Embodiments of the present disclosure are further described in detail below with reference to the accompanying drawings.

The method for playing back a virtual scene provided by the present disclosure can be applied to an electronic device having a data processing function, a storage function and a display function, such as a computer, a tablet computer, and a mobile phone. An application program for recording and playing back the virtual scene can be run on the electronic device, and the electronic device can be communicatively connected to a server.

As shown in FIG. 1, FIG. 1 is a flowchart of a method for playing back a virtual scene according to an embodiment of the present disclosure.

Step S10: Receive a recording instruction to record state data at beginning of the recording and change data during a recording process, of a virtual scene including at least one model.

The virtual scene includes at least one model, such as persons, animals, cars, and trees, and each model has state data, including a physical form, a location, and an action of the model. It can be understood that the state data further includes lighting information of the model, partial script states, and so on.

During the recording, the state data that has changed is recorded at a predetermined time interval, as the change data. For example, if a car moves from a location 1 to a location 2 at a predetermined time interval, the location 2 is recorded as the change data. It can be understood that if the car remains at the location 1 at a predetermined time interval without any change, it is not recorded.

It can be understood that the changed state data of different models can be recorded at different predetermined time intervals. For example, the time interval for recording the changed state data of models (for example, buildings, trees, etc.) that change less frequently in the virtual scene may be larger than the time interval for recording the changed state data of models (for example, persons, cars, etc.) that change more frequently in the virtual scene. In this way, the amount of data recorded during the recording process can be reduced, so that occupation of storage space is reduced.

It can be understood that a first electronic device of a first user (that is, a recorder) receives a recording instruction and performs recording. The recording instruction may be triggered by an interaction between the first user and the first electronic device. For example, the first user clicks a recording button displayed on the first electronic device, or the recording instruction may be automatically triggered by the first electronic device based on a preset condition. The preset conditions include duration of the first user in the virtual scene, orientation information, current location information, and the like. It can be understood that, during the recording process, an account of the recorder, a nickname of the recorder, recording completion time, modeling data index, a UI control state, a predefined animation event, and camera change trajectories and parameters of an electronic device that performs recording (such as, the first electronic device), other user information, a game trigger, a game logic script, and so on are further recorded.

It can be understood that all data recorded above can be stored in the electronic device that performs recording, or may be stored in a server communicating with the electronic device.

Step S11: Receive a playback instruction, and play back the virtual scene based on the state data and the change data. When the virtual scene is played back, an operation instruction is received and an operation result is displayed. The operation instruction includes controlling at least one model of the virtual scene and/or generating an interaction event with at least one model of the virtual scene.

It can be understood that a second electronic device of a second user (that is, a viewer) receives the playback instruction, obtains the recorded state data and the change data from the server, so as to play back the virtual scene.

The resolution of at least one model is determined according to performance parameters of the electronic device (for example, the second electronic device) that plays back or an operation instruction, and the virtual scene is rendered and played back based on the modeling data of the at least one model.

It can be understood that each model has a different level of resolution, and here, a corresponding level of resolution of each model is determined according to performance parameters of the second electronic device or an operation instruction of the second user. Then, it plays back by using a corresponding level of resolution and corresponding modeling data.

It can be understood that the corresponding modeling data can be stored in the server, and the corresponding modeling data can be obtained according to the corresponding level of resolution. It can be understood that the corresponding modeling data can be obtained from the server by using the recorded modeling data index.

It can be understood that, for each model, fixed modeling data can be stored in the server, and therefore it may render and play back by using the fixed modeling data according to the corresponding level of resolution. Optionally, for each model, different levels of modeling data corresponding to different levels of resolutions can be stored in the server, and the corresponding level of modeling data can be selected according to the corresponding level of resolution. Therefore, it may render and play back by using the corresponding level of modeling data according to the corresponding level of resolution.

It can be understood that, playing back by using the corresponding level of resolution and the corresponding modeling data can ensure smooth playback of the virtual scene on the second electronic device.

According to the above method, even if the performance of the electronic device (such as the first electronic device) recording the virtual scene is relatively low, the high-quality virtual scene can be smoothly played back on a high-performance electronic device (such as the second electronic device) that performs playing back.

In addition, it can be understood that the first user and the second user may be two different users, or may be the same user, and the first electronic device and the second electronic device may be two different electronic devices, or may be the same electronic device. It can be understood that in a case that the first electronic device and the second electronic device are the same electronic device, when the electronic device receives the playback instruction, the recorded state data and the change data are obtained from the electronic device, and the virtual scene is played back.

When the virtual scene is played back, controlling at least one model of the virtual scene includes: controlling at least one existing model in the virtual scene, or, based on an operation instruction, adding a new model in the virtual scene and controlling the new model.

For example, an application program may be a racing game, and the played back virtual scene may be a racing scene in which multiple racing cars are on racing tracks. The virtual scene includes multiple existing racing car models. Based on a playback function provided by the application program, during playing back the virtual scene, an existing racing car in the virtual scene can be directly controlled according to an operation instruction of the second user, and the racing game can be continued. In this case, the second user can choose to control a racing car in the played back virtual scene through function options provided by a user interface of the application program, and the second user controls the selected racing car by using an input device of the second electronic device, for example, when the second electronic device is a smart phone, the selected racing car is controlled by using a touch screen of the smart phone. Another racing car in the virtual scene can be automatically controlled by the application program. In this way, the racing game is continued.

On the other hand, a new model can be added according to the operation instruction of the second user. For example, a character model representing virtual identity of the second user in the application program can be added, and the character model can be controlled to move in the virtual scene. For example, the character model can be controlled to be taken a picture with the racing car in the track as the background. In this case, the second user can choose to add a character model representing his own virtual identity in the application program in the virtual scene through the function options provided by a user interface of the application program, and the second user can control the activity of the character model in the virtual scene by using an input device of the second electronic device. In this case, the application program can implement the above functions by using two parallel processes, one is used to play back the virtual scene according to the stored state data and the change data, and the other is used to perform an activity of the newly added character model according to the input of the second electronic device.

In some embodiments, when the virtual scene is played back on a display screen of the second electronic device, the played back virtual scene can be displayed on only a part of the display screen. For example, the display screen of the second electronic device has a screen-like area to display the played back virtual scene, that is, to display the played back virtual scene as a picture-in-picture. In some embodiments, when the played back virtual scene is displayed as a picture-in-picture, the character model representing the virtual identity of the second user in the application program can be active outside the playback screen-like area of the display screen of the second electronic device, that is, the second user can watch, as a virtual identity, the playback of the virtual scene in the virtual space provided by the application program. Further, the second user can further control the character model, so that the character model enters the screen-like area in which the virtual scene is played back, and interacts with the model in the played back virtual scene.

In some embodiments, at least two different display areas may further be displayed on the display screen of the second electronic device, that is, split-screen display, and different scenes may be respectively displayed in these different display areas. In some embodiments, for example, two display areas can be displayed on the display screen of the second electronic device. A playback virtual scene, such as a racing scene, is displayed in a first display area. A virtual scene in which the second user is located is displayed in a second display area, for example, the scene in which the second user is driving a racing car or the scene in which the second user is walking freely on the racing track, so that a game effect of performing a space separated race between the second user and a playback virtual scene may be implemented. It can be understood that, in some embodiments, for example, three display areas may be displayed on the display screen of the second electronic device, the contents displayed in the first display area and the second display area are similar to those in the above embodiment. However, any scene that the second user is interested in may be displayed in the third display area, for example, a scene showing racing time, scores, etc. on a racetrack.

In addition, when the virtual scene is played back, generating an interaction event with at least one model of the virtual scene includes: adding a new model to the virtual scene based on an operation instruction, so that an interaction event between at least one existing model in the virtual scene and the new model is generated.

Similarly, a racing game is used as an example, and a new model can be added according to the operation instruction of the second user. For example, a racing car is added, and competes with other existing racing cars in the playback racing scene.

It can be understood that, during playing back the virtual scene, a new model is added to the virtual scene based on the operation instruction, and when an interaction event between at least one existing model in the virtual scene and the new model is generated, a game trigger receives the interaction event and determines a source of the interaction event, so that an instruction to execute a game logic script is triggered by the new model added in the virtual scene, and an instruction to execute a game logic script is not triggered by the existing model in the virtual scene. Therefore, only state data of the new model added in the virtual scene is affected, and the state data of the existing model in the playback virtual scene is not affected. In some embodiments, in the playback racing scene, for example, the added racing car simultaneously competes with other existing racing cars. When the added racing car collides with an existing racing car (that is, an interaction event occurs), there is no effect on the state data of the existing racing car, that is, the existing racing car continues to be driven according to a driving direction in recording, and the driving direction or driving speed is not changed due to the collision. In addition, when the above interaction event occurs, there is an effect on the added racing car, that is, a driving direction or a driving speed of the added racing car is changed due to the collision.

In some embodiments, the playback is ended when at least one model of the virtual scene is controlled and/or an interaction event with at least one model of the virtual scene is generated. After the playback is ended, the second user can continue to play the game in the virtual scene.

It can be understood that, in the playback racing scene, when an interaction event occurs between the added racing car and at least one model of the virtual scene, for example, when the added racing car collides with an existing racing car, a game trigger receives the interaction event and determines a source of the interaction event, so that an instruction to execute a game logic script is triggered by both the existing model and the added new model in the virtual scene, the state data of the existing model and the added new model in the virtual scene are both affected, and the playback is ended. For example, a new model (for example, an added racing car) is added in the playback virtual scene, and when the new model interacts with the existing model, for example, when the added racing car collides with the existing racing car, the playback is ended, and the added racing car continues to compete in the racing game and affects the outcome of the race.

In some embodiments, after the playback is ended, the added racing car continues to race in the racing game. When the added racing car collides with the original racing car, there is an effect on the state data of the original racing car, that is, a driving direction or a driving speed of the original racing car is changed due to the collision. In addition, the added racing car is also affected, that is, a driving direction or a driving speed of the added racing car is also changed due to the collision.

According to the above method, not only the virtual scene can be played back, but also the playback virtual scene can be controlled and/or an interaction with the playback virtual scene can be performed, so that user experience is improved.

It can be understood that the above operation instruction of the second user further includes: pausing or resuming playing back the virtual scene, adjusting the progress of the playback, and adjusting a viewing angle of the playback.

During playing back the virtual scene, the second user can pause or resume playing back the virtual scene at any time, and can adjust the playback progress, for example, control the progress bar to control the playback progress. In addition, a camera control right of the second electronic device may further be provided to adjust the viewing angle of playback in the playback virtual scene, so that the second user is allowed to watch the playback virtual scene with a free angle of view. Therefore, the second user can watch content of any angle of view in the virtual scene.

It can be understood that the above operation instruction of the second user further includes: recording the virtual scene being played back and/or the virtual scene after the playback is ended. For the virtual scene being played back and/or the virtual scene after the playback end is ended, a recording instruction may be triggered by an interaction between the second user and the second electronic device, or a recording instruction may be automatically triggered by the second electronic device based on a preset condition, so that the state data of the virtual scene at the beginning of the recording and the change data of the virtual scene during the recording process are recorded. The preset condition includes duration of the second user in the virtual scene, orientation information, current location information, and the like.

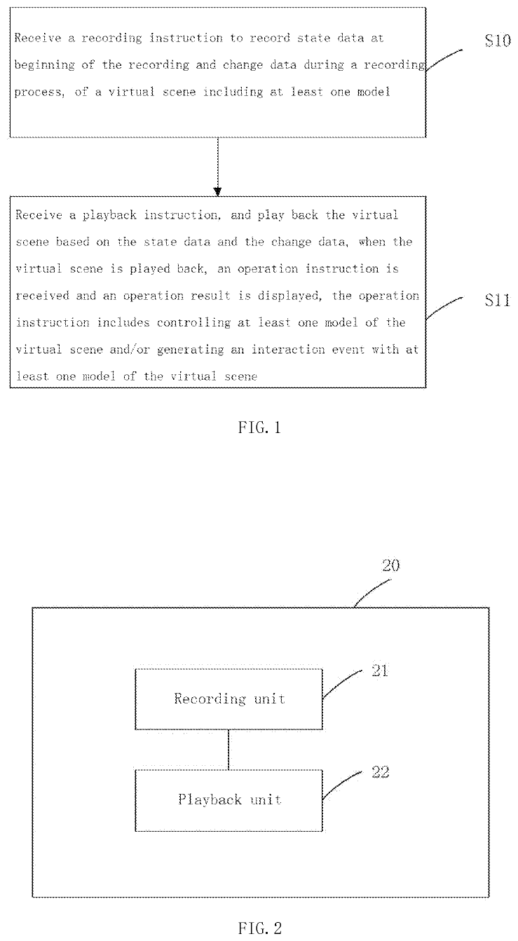

The present disclosure further provides an apparatus for playing back a virtual scene. FIG. 2 is a structural diagram of an apparatus for playing back a virtual scene. The apparatus 20 includes: a recording unit 21, configured to: receive a recording instruction to record state data at beginning of the recording and change data during a recording process, of a virtual scene including at least one model; and a playback unit 22, configured to: receive a playback instruction, and play back the virtual scene based on the state data and the change data. When the virtual scene is played back, an operation instruction is received and an operation result is displayed. The operation instruction includes controlling at least one model of the virtual scene and/or generating an interaction event with at least one model of the virtual scene. In addition, it can be understood that the recording unit 21 and the playback unit 22 may be implemented by a processor having functions of these modules or units in an electronic device.

The present disclosure further provides a computer-readable storage medium, and instructions are stored on the storage medium. When the instructions are executed on a computer, the computer performs the method for playing back a virtual scene shown in FIG. 1.

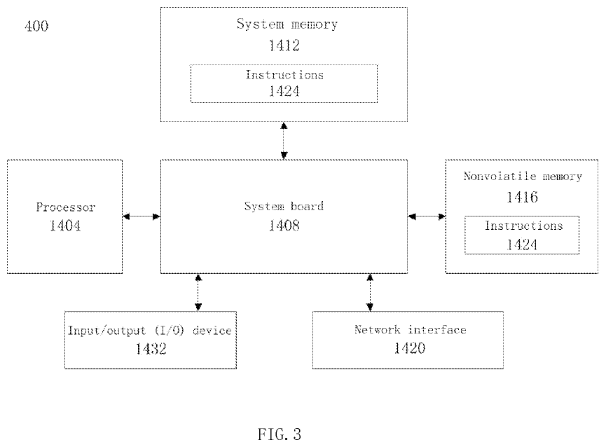

Referring to FIG. 3, FIG. 3 schematically shows an electronic device 400 according to an embodiment of the present invention.

In an embodiment, the electronic device 400 may include one or more processors 1404, a system board 1408 connected to at least one of the processors 1404, a system memory 1412 connected to the system board 1408, a nonvolatile memory (NVM) 1416 connected to the system board 1408, and a network interface 1420 connected to the system board 1408.

In some embodiments, the processor 1404 may include one or more single-core or multi-core processors. In some embodiments, the processor 1404 may include any combination of a general-purpose processor and a special-purpose processor (such as, a graphics processing unit, an application processor, or a baseband processor). The processor 1404 may be configured to perform various conforming embodiments, for example, the embodiment shown in FIG. 1.

In some embodiments, the system board 1408 may include any suitable interface controller, to provide any suitable interface for at least one of the processors 1404 and/or any suitable device or component communicating with the system board 1408.

In some embodiments, the system board 1408 may include one or more memory controllers to provide an interface connected to the system memory 1412. The system memory 1412 may be used to load and store data and/or an instruction. In some embodiments, the system memory 1412 of the electronic device 400 may include any suitable volatile memory, such as a suitable dynamic random access memory (DRAM).

The NVM 1416 may include one or more tangible and non-transitory computer-readable media for storing data and/or the instruction. In some embodiments, the NVM 1416 may include any suitable nonvolatile memory such as a flash memory and/or any suitable nonvolatile storage device, such as at least one of a HDD (Hard Disk Drive, hard disk drive), a CD (Compact Disc, Compact Disc) drive, and a DVD (Digital Versatile Disc, Digital Versatile Disc) drive.

The NVM 1416 may include a portion of storage resources installed on the apparatus of the electronic device 400, or may be accessed by a device, but is not necessarily part of a device. For example, the nonvolatile memory 1416 may be accessed over a network via the network interface 1420.

In particular, the system memory 1412 and the NVM 1416 may respectively include: a temporary copy and a permanent copy of the instruction 1424. The instruction 1424 may include: an instruction that causes the electronic device 400 to implement the method shown in FIG. 1 when executed by at least one of the processors 1404. In some embodiments, the instruction 1424, hardware, firmware, and/or software components thereof may additionally/alternatively reside in the system board 1408, the network interface 1420, and/or the processor 1404.

The network interface 1420 may include a transceiver for providing a radio interface for the electronic device 400 to communicate with any other suitable devices (such as, a front-end module and an antenna) by using one or more networks. In some embodiments, the network interface 1420 may be integrated with other components of the electronic device 400. For example, the network interface 1420 may be integrated into at least one of the processors 1404, the system memory 1412, the NVM 1416, and a firmware device (not shown) having an instruction, and when at least one of the processors 1404 executes the instruction, the electronic device 400 implements the method shown in FIG. 1.

The network interface 1420 may further include any suitable hardware and/or firmware to provide a multiple-input multiple-output wireless interface. For example, the network interface 1420 may be a network adapter, a wireless network adapter, a telephone modem, and/or a wireless modem.

In one embodiment, at least one of the processors 1404 may be packaged with one or more controllers used for the system board 1408 to form a system in a package (SiP). In one embodiment, at least one of the processors 1404 may be integrated on the same die with one or more controllers used for the system board 1408 to form a system on a chip (SoC).

The electronic device 400 may further include: an input/output (I/O) device 1432 connected to the system board 1408. The I/O device 1432 may include a user interface, so that a user can interact with the electronic device 400; peripheral components can also interact with the electronic device 400 by using a design of a peripheral component interface. In some embodiments, the electronic device 400 further includes a sensor for determining at least one of environmental conditions and location information related to the electronic device 400.

In some embodiments, the I/O device 1432 may include, but is not limited to, a display (such as, a liquid crystal display and a touch screen display), a speaker, a microphone, one or more cameras (such as, a still image camera and/or a video camera), a flashlight (such as, a LED flash), and a keyboard.

The server in the present invention may have a hardware structure similar to that of the electronic device 400.

The illustrated components may be implemented in hardware, software, and firmware or a combination of software, hardware, and firmware. Embodiments of the present disclosure may be implemented as a computer program or program code executed on a programmable system including at least one processor, a storage system (including a volatile memory and a non-volatile memory and/or a storage element), at least one input device, and at least one output device.

Program code can be applied to input instructions to perform the functions described in the present disclosure and to generate output information. The output information may be applied to one or more output devices in a known manner. For purposes of the present disclosure, a system used for processing the instructions and including the processor 1404 includes any system with a processor such as a digital signal processor (DSP), a microcontroller, an application specific integrated circuit (ASIC), or a microprocessor.

The program code can be implemented in a high-level programming language or an object-oriented programming language to communicate with a processing system. The program code can also be implemented in an assembly language or a machine language, if desired. In fact, the mechanism described in the present disclosure is not limited in scope to any particular programming language. In either case, the language may be an assembly language or an interpreted language.

In some cases, the disclosed embodiments may be implemented in hardware, firmware, software, or any combination thereof. The disclosed embodiments can further be implemented as instructions carried by or stored on one or more transitory or non-transitory machine-readable (for example, computer-readable) storage media, which can be read and executed by one or more processors. For example, the instructions may be distributed over a network or over another computer-readable medium. Therefore, a machine-readable medium can include any mechanism for storing or transmitting information in a machine (for example, a computer) readable form, and includes, but is not limited to, a floppy disk, an optical disk, an optical disk, a compact disc read-only memory (CD-ROM), a magnetic optical disc, a read only memory (ROM), a random access memory (RAM), an erasable programmable read only memory (EPROM), an electrically erasable programmable read only memory (EEPROM), a magnetic card or an optical card, a flash memory, or a tangible machine-readable memory for transmitting information (for example, a carrier wave, an infrared signal, and a digital signal) using the Internet in electrical, optical, acoustic, or other forms of propagating signals. Therefore, the machine-readable medium includes any type of machine-readable medium suitable for storing or transmitting electronic instructions or information in a machine (for example, a computer) readable form.

In the drawings, some structural or methodological features may be shown in a particular arrangement and/or order. However, it should be understood that no such specific arrangement and/or ordering is required. Rather, in some embodiments, features may be described in a different manner and/or order than shown in the illustrative figures. In addition, the inclusion of structural or methodological features in a particular figure does not imply that all embodiments need to include such features, and in some embodiments, these features may not be included or may be combined with other features.

It should be noted that each module/unit mentioned in each device embodiment of the present disclosure is a logical module/unit. Physically, a logical module/unit may be a physical module/unit or may be a part of a physical module/unit, or may be implemented by a combination of multiple physical modules/units. The physical implementation of these logical modules/units is not the most important, and the combination of functions implemented by these logical modules/units is the key to solving the technical problems raised by the present disclosure. In addition, in order to highlight the innovative part of the present disclosure, the above device embodiments of the present disclosure do not introduce modules/units that are not closely related to solving the technical problems raised in the present disclosure, which does not mean that other modules/units do not exist in the device embodiments.

It should be noted that in the examples and descriptions of this patent, relative terms such as first and second are only used to distinguish one entity or operation from another entity or operation, and do not necessarily require or imply there is no such actual relationship or sequence between these entities or operations. Moreover, the terms “include”, “comprise”, or their any other variant are intended to cover a non-exclusive inclusion, so that a process, a method, an article, or a device that includes a list of elements not only includes those elements but also includes other elements which are not expressly listed, or further includes elements inherent to such process, method, article, or device. An element preceded by “includes a . . . ” does not, without more constraints, preclude the existence of additional identical elements in the process, method, article, or device that includes the element.

Although the present disclosure has been shown and described with reference to certain preferred embodiments of the present disclosure, the person skilled in the art should understand that various changes in form and details may be made therein without departing from the spirit and scope of the present disclosure.

We claim:

1. A method for playing back a virtual scene, used for an electronic device, the method comprising:
receiving a recording instruction to record state data at beginning of the recording and change data during a recording process, of the virtual scene comprising at least one model; and
receiving a playback instruction, and playing back the virtual scene based on the state data and the change data, wherein,
when the virtual scene is played back, an operation instruction is received and an operation result is displayed, the operation instruction comprising any combination of controlling at least one model of the virtual scene and generating an interaction event with at least one model of the virtual scene.

2. The method according to claim 1, wherein the controlling at least one model of the virtual scene comprises:
controlling at least one existing model in the virtual scene, or, adding a new model in the virtual scene based on the operation instruction and controlling the new model.

3. The method according to claim 1, wherein the generating the interaction event with at least one model of the virtual scene comprises:
adding a new model to the virtual scene based on the operation instruction, so that an interaction event is generated between at least one existing model in the virtual scene and the new model.

4. The method according to claim 1, further comprising:
ending the playback in a case that at least one model of the virtual scene is controlled and/or an interaction event with at least one model of the virtual scene is generated.

5. The method according to claim 1, wherein the state data comprises:
a physical form, a position, and an action of the at least one model.

6. The method according to claim 5, wherein the change data comprises:
the state data that is changed and that is recorded at predetermined time interval.

7. The method according to claim 6, wherein the playing back the virtual scene based on the state data and the change data further comprises:
determining resolutions of the at least one model according to a performance parameter of the electronic device or the operation instruction, and rendering and playing back the virtual scene based on modeling data of the at least one model.

8. The method according to claim 7, wherein the operation instruction further comprises:
pausing or resuming playing back the virtual scene; or
adjusting a viewing angle of the playback; or
adjusting a progress of the playback.

9. A computer-readable storage medium having stored thereon instructions configured to, when executed on a computer, cause the computer to perform the method for playing back a virtual scene according to claim 1.

10. An electronic device, comprising:
one or more processors;
one or more memories;
wherein, one or more programs are stored in the one or more memories, and when the one or more programs are executed by the one or more processors, the electronic device is caused to perform the method for playing back a virtual scene according to claim 1.

11. A computer program product, comprising computer-executable instructions, wherein the instructions are executed by a processor to implement the method for playing back a virtual scene according to claim 1.
